(19) United States
(12) Patent Application Publication
(10) Pub. No.: US 2026/0371053 A1
(43) Pub. Date: Nov. 19, 2026

(54) SYSTEM AND METHOD FOR A COMMUNICATION SYSTEM BASED ON BLUETOOTH LOW ENERGY PROTOCOL

(71) Applicant: Harman International Industries, Incorporated, Stamford, CT (US)

(72) Inventor: Shuibao GAN, Shenzhen (CN)

(73) Assignee: Harman International Industries, Incorporated, Stamford, CT (US)

(21) Appl. No.: 19/749,995

(22) Filed: Jul. 22, 2026

Related U.S. Application Data
(63) Continuation of application No. PCT/CN2024/074003, filed on Jan. 25, 2024.

(51) Int. Cl. H04W 4/80

(52) U.S. Cl. CPC H04W 4/80

(57) ABSTRACT

A communication method for a communication system based on a Bluetooth low energy protocol. The communication system includes a transmitting device and a target device. The communication method includes the transmitting device configured to: acquire a target data content, acquire a maximum transmission unit data of the target device, compare a data length of the target data content with the maximum transmission unit data, generate a plurality of data transmission packets corresponding to the target data content according to a preset rule when the data length of the target data content is greater than the maximum transmission unit data, and send the plurality of data transmission packets to the target device based on the Bluetooth low energy protocol. The target device is configured to: receive a plurality of data transmission packets corresponding to the target data content, and determine the target data content based on the data transmission packets.

### CROSS-REFERENCE TO RELATED APPLICATIONS

This application is a continuation of International Application No. PCT/CN2024/074003, filed on Jan. 25, 2024. The disclosure of the above application is incorporated herein by reference.

### FIELD

The present disclosure relates to communication field, and more particularly, to a communication system and method for a communication system based on a Bluetooth low energy protocol.

### BACKGROUND

The statements in this section merely provide background information related to the present disclosure and may not constitute prior art.

With the development of communication technology, the Bluetooth low energy (BLE) processing is widely used in commercial fields. The communication method for Bluetooth low energy processing is also faced with higher requirements.

Currently, between Bluetooth headsets/speakers and companion App, it is necessary to transmit data to control the behavior of Bluetooth headsets/speakers, such as querying device information, modifying the Equalizer, customizing personalized names, upgrading firmware, etc. As Bluetooth devices become more functional, more and more data is transmitted between companion Apps and devices. But the MTU (MAXIMUM TRANSMISSION UNIT) of BLE is usually less than 200 bytes. Moreover, the maximum transmission data amount of different devices is different, and the data exceeding this data amount cannot be sent. In order to achieve good consideration for different devices, it is usually necessary to set related control commands according to the maximum transmission data amount of the controlled devices, which on the one hand leads to the failure to realize the transmission of large-size complex control commands, which is not conducive to the good control of related target devices. On the other hand, for compatibility with different devices, the related control command is designed by the target device with the smallest value of the maximum transmission data amount among multiple target devices, which makes the control command undergo unnecessary size reduction.

Therefore, there is a need for a communication method for a communication system based on a Bluetooth low energy protocol, which can realize a flexible and scalable simple command interaction method, and the transmitted target data content (for example, control command) can be independent of the MTU of the target device, which means that good and reliable transmission of the target command can be realized regardless of the MTU value of the target device, and data with larger size can be transmitted successfully.

### SUMMARY

This section provides a general summary of the disclosure and is not a comprehensive disclosure of its full scope or all of its features.

According to one aspect of the present disclosure, a communication method for a communication system based on a Bluetooth low energy protocol is provided. The communication system comprises a transmitting device and a target device. The communication method comprises the transmitting device is configured to: acquire a target data content; acquire a maximum transmission unit data of the target device; compare a data length of the target data content with the maximum transmission unit data; generate a plurality of data transmission packets corresponding to the target data content according to a preset rule when the data length of the target data content is greater than the maximum transmission unit data; send the plurality of data transmission packets to the target device based on a Bluetooth low energy protocol; the target device is configured to: receive a plurality of data transmission packets corresponding to the target data content, and determine the target data content based on the plurality of data transmission packets; wherein the data length of each data transmission packet is less than or equal to the maximum transmission unit data of the target device.

In one or more embodiments of the present disclosure, wherein the step of generating a plurality of data transmission packets corresponding to the target data content according to a preset rule when the data length of the target data content is greater than the maximum transmission unit data comprises: generating command identification verification information corresponding to the target data content, wherein the command identification verification information comprises a command identification code; determining, based on the data length of the target data content and the maximum transmission unit data, a total number of data transmission packets corresponding to the target data content and data transmission information corresponding to each data transmission packet, wherein the data transmission information corresponding to each data transmission packet comprises a data transmission packet code corresponding to the data transmission packet and fragment data of the target data content corresponding to the data transmission packet; generating, according to a preset transmission format, a plurality of data transmission packets corresponding to the target data content based on the command identification verification information, the total number of data transmission packets and the data transmission information corresponding to each data transmission packet.

In one or more embodiments of the present disclosure, wherein the step of determining, based on the data length of the target data content and the maximum transmission unit data, a total number of data transmission packets corresponding to the target data content and data transmission information corresponding to each data transmission packet comprises: calculating, based on the maximum transmission unit data and the preset transmission format, a data length threshold in each data transmission packet; determining, based on the data length threshold and the data length of the target data content, the total number of data transmission packets and the length of the fragment data of the target data content corresponding to each data transmission packet; generating, the fragment data of the target data content corresponding to each data transmission packet and the data transmission packet code corresponding to the data transmission packet based on the target data content and the length of the fragment data of the target data content corresponding to each data transmission packet; wherein the data transmission packet code corresponding to each data transmission packet is associated with the order of fragment data of the target data content in each data transmission packet in the target data content.

In one or more embodiments of the present disclosure, wherein the command identification verification information further comprises a verification code corresponding to the target data content.

In one or more embodiments of the present disclosure, wherein the preset transmission format comprises a transmission header part and a transmission payload part; and the step of generating, according to a preset transmission format, a plurality of data transmission packets corresponding to the target data content based on the command identification verification information, the total number of data transmission packets and the data transmission information corresponding to each data transmission packet comprises: for each data transmission packet: generating the transmission payload part via the verification code, the total number of data transmission packets and the data transmission information of the data transmission packets; generating the transmission header part via the command identification code; splicing the transmission header part and the transmission payload part to obtain the data transmission packet.

In one or more embodiments of the present disclosure, wherein the transmission header part further comprises transmission payload length data; and the step of generating the transmission header part via the command identification code for each data transmission packet comprises: for each data transmission packet: determining the data length of the transmission payload part of the data transmission packet and taking it as the transmission payload length data; and splicing the command identification code with the transmission payload length data to obtain a transmission header part. In one or more embodiments of the present disclosure, wherein data in the data transmission packet is expressed in hexadecimal code.

In one or more embodiments of the present disclosure, wherein the step of receiving a plurality of data transmission packets corresponding to the target data content, and determining the target data content based on the plurality of data transmission packets comprises: determining a plurality of data transmission packets corresponding to the target data content based on the command identification code; determining, according to the preset transmission format, the total number of the data transmission packets and data transmission information corresponding to each data transmission packet based on the plurality of data transmission packets; and splicing fragment data of the target data content in a plurality of data transmission packets corresponding to the target data content based on data transmission information corresponding to each data transmission packet to obtain the target data content.

In one or more embodiments of the present disclosure, wherein the step of splicing fragment data of the target data content in a plurality of data transmission packets corresponding to the target data content based on data transmission information corresponding to each data transmission packet to obtain the target data content comprises: determining data transmission packet codes of each data transmission packet; and splicing, according to the data transmission packet code of each data transmission packet, the fragment data of the target data content in each data transmission packet to obtain the target data content.

In one or more embodiments of the present disclosure, wherein the data transmission packet further comprises a verification code, and splicing, according to the data transmission packet code of each data transmission packet, the fragment data of the target data content in each data transmission packet to obtain the target data content comprises: acquiring the verification code in each data transmission packet; and only under the condition that the verification codes from each data transmission packet are the same, the step of splicing, according to the data transmission packet code of each data transmission packet, the fragment data of the target data content in each data transmission packet is executed. In one or more embodiments of the present disclosure, wherein the target device is a Bluetooth speaker or a Bluetooth headset.

According to an aspect of the present disclosure, a communication system based on Bluetooth low energy protocol is provided, which comprises a transmitting device; and a target device, which communicates with the transmitting device based on Bluetooth low energy protocol. The communication system based on the Bluetooth low energy protocol is configured to execute the communication method for the communication system based on the Bluetooth low energy protocol as previously described.

The significance and benefits of the present disclosure will be clear from the following description of the one or more embodiments. However, it should be understood that those one or more embodiments are merely examples of how the disclosure can be implemented, and the meanings of the terms used to describe the disclosure are not limited to the specific ones in which they are used in the description of the embodiments.

Other systems, methods, features, and advantages of the disclosure will be, or will become, apparent to one with skill in the art upon examination of the following figures and detailed description. It is intended that all such additional systems, methods, features, and advantages be included within this description, be within the scope of the disclosure, and be protected by the appended claims.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 illustrates a flow chart of communication method for a communication system based on a Bluetooth low energy protocol according to one or more embodiments of the present disclosure;

FIG. 2 illustrates a schematic diagram of a communication system based on a Bluetooth low energy protocol according to one or more embodiments of the present disclosure;

FIG. 3 illustrates a flow chart of a process according to one or more embodiments of the present disclosure;

FIG. 4 illustrates a flow chart of a process according to one or more embodiments of the present disclosure;

FIG. 5 illustrates a schematic diagram of a first data transmission packet according to one or more embodiments of the present disclosure;

FIG. 6 illustrates a schematic diagram of a second data transmission packet according to one or more embodiments of the present disclosure; and

FIG. 7 illustrates a schematic diagram of a third data transmission packet according to one or more embodiments of the present disclosure.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

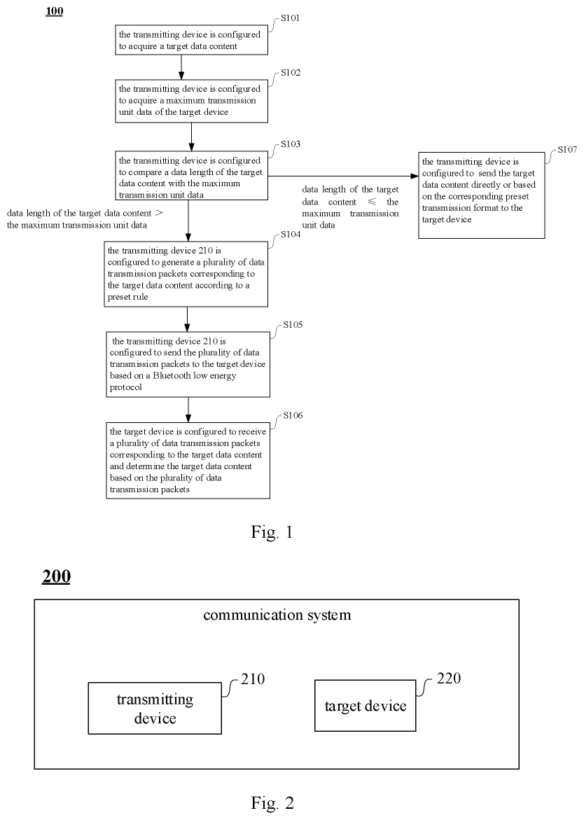

FIG. 1 illustrates a schematic diagram of communication method 100 for a communication system 200 based on a Bluetooth low energy protocol according to one or more embodiments of the present disclosure. FIG. 2 illustrates a schematic diagram of a communication system 200 based on a Bluetooth low energy protocol according to one or more embodiments of the present disclosure.

Wherein the communication system 200 based on a Bluetooth low energy protocol includes a transmitting device 210 and a target device 220.

Wherein the transmitting device 210 presents a device that transmits data, which may be, for example, a control device, such as a mobile terminal device, or may also be an audio playback device, and one or more embodiments of the present disclosure are not limited to this.

Wherein the target device 220 presents the device that receives the data, which can be, for example, a Bluetooth player or an earphone, such as a Bluetooth portable player. One or more embodiments of the present disclosure are not limited thereto.

Wherein the transmitting device 210 and a target device 220 are communicated with each other based on Bluetooth low energy protocol (BLE protocol), for example BLE 4.2 protocol, or BLE 5.2 protocol. It should be understood that one or more embodiments of the present disclosure are not limited by specific protocol versions.

As shown in FIG. 1, according to the communication method 100: firstly, in step S101, the transmitting device 210 is configured to acquire a target data content. Wherein the target data content represents the content to be sent by the transmitting device, it can be a control command, or it also can be image information or data information for transmitting. The one or more embodiments of the present disclosure are not limited to this.

Then, in step S102, the transmitting device 210 is configured to acquire a maximum transmission unit data of the target device.

The terms “maximum transmission unit data” refers to the maximum amount of data that can be transmitted in a protocol data unit (target device), i.e., how many bytes can be transmitted to the target device at one time.

Then in step S103, the transmitting device 210 is configured to compare a data length of the target data content with the maximum transmission unit data.

Wherein the data length of the target data content represents the data amount of the target data. For example, if the data length of the target data content is 256 bytes, and the maximum transmission unit data is 200 bytes, than the data length of the target data content is larger than the maximum transmission unit data.

Based on the comparison in step S103, in step S104, the transmitting device 210 is configured to generate a plurality of data transmission packets corresponding to the target data content according to a preset rule when the data length of the target data content is greater than the maximum transmission unit data.

Specifically, if the data length of the target data content is smaller than or equal to the maximum transmission unit data of the target device, at step S107, the transmitting device is configured to send the target data content directly or based on the corresponding preset transmission format to the target device. Specifically, the target data content for example can be directly send to the target device, or it can be sent to the target device based on the corresponding preset transmission format, the corresponding preset transmission format for example can be same for the preset transmission format for data transmission packet as described below, or can be different preset transmission format. The one or more embodiments of the present disclosure are not limited to this.

Wherein when the data length of the target data content is greater than the maximum transmission unit data, the transmitting device 210 is configured to generate a plurality of data transmission packets corresponding to the target data content according to a preset rule. Wherein the plurality of data transmission packets presents data unit used to transmit data, i.e., a data segment or a data frame for transmitting data.

Wherein the process of generating a plurality of data transmission packets corresponding to the target data content according to a preset rule can be described in detail. For example, it comprises: generating command identification verification information corresponding to the target data content, wherein the command identification verification information comprises a command identification code; determining, based on the data length of the target data content and the maximum transmission unit data, a total number of data transmission packets corresponding to the target data content and data transmission information corresponding to each data transmission packet, wherein the data transmission information corresponding to each data transmission packet comprises a data transmission packet code corresponding to the data transmission packet and fragment data of the target data content corresponding to the data transmission packet; generating, according to a preset transmission format, a plurality of data transmission packets corresponding to the target data content based on the command identification verification information, the total number of data transmission packets and the data transmission information corresponding to each data transmission packet.

It should be understood that the above is only an example, and the one or more embodiments of the present disclosure are not limited to this. For example, the detailed number of the data transmission packets for example can be determined by the data length of the target data content and the maximum transmission unit data. Then in step S105, the transmitting device 210 is configured to send the plurality of data transmission packets to the target device based on a Bluetooth low energy protocol.

For example, according to the detailed arrangement of the Bluetooth low energy protocol, the plurality of data transmission packets can be sent to the target device during the different transmission periods, or it can be sent at same time through the different channels. The one or more embodiments of the present disclosure are not limited to this.

Then, in step S106, the target device 220 is configured to receive a plurality of data transmission packets corresponding to the target data content and determine the target data content based on the plurality of data transmission packets. For example, the step of receiving a plurality of data transmission packets corresponding to the target data content, and determining the target data content based on the plurality of data transmission packets comprises: determining a plurality of data transmission packets corresponding to the target data content based on the command identification code; determining, according to the preset transmission format, the total number of the data transmission packets and data transmission information corresponding to each data transmission packet based on the plurality of data transmission packets; and splicing fragment data of the target data content in a plurality of data transmission packets corresponding to the target data content based on data transmission information corresponding to each data transmission packet to obtain the target data content. Wherein the data length of each data transmission packet is less than or equal to the maximum transmission unit data of the target device.

Based on the above, in this application, when the data length of the target data content is greater than the maximum transmission unit data, by generating a plurality of data transmission packets corresponding to the target data content according to a preset rule, the transmitting device still can send the whole target data content by the plurality of data transmission packets with the data length less than or equal to the maximum transmission unit data of the target device. Thus, by the communication method for a communication system based on a Bluetooth low energy protocol in the disclosure, it can realize a flexible and scalable simple command interaction method, and the transmitted target data content (for example, control command) can be independent of the MTU of the target device, which means that good and reliable transmission of the target data content can be realized regardless of the MTU value of the target device, and data with larger size can be transmitted successfully.

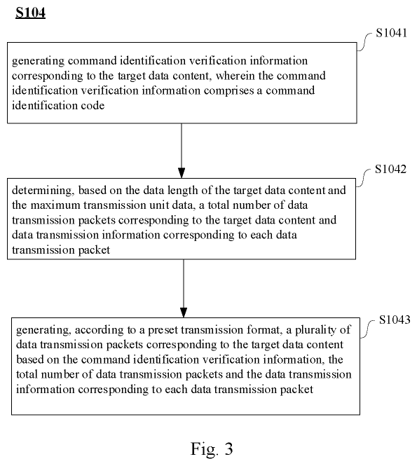

In one or more embodiments, wherein the process S104 of generating a plurality of data transmission packets corresponding to the target data content according to a preset rule when the data length of the target data content is greater than the maximum transmission unit data can be described in more detail. FIG. 3 illustrates a schematic diagram of process S104 according to one or more embodiments of the present disclosure.

Referring to FIG. 3, the above process S104 comprises: firstly, in step S1041, command identification verification information is generated corresponding to the target data content, wherein the command identification verification information comprises a command identification code.

Wherein the command identification code represents the command code corresponding to the target data content. For example, the command identification code can be 1 byte and can be in hexadecimal form. Then in step S1042, a total number of data transmission packets corresponding to the target data content and data transmission information corresponding to each data transmission packet is determined based on the data length of the target data content and the maximum transmission unit data.

Wherein a total number of data transmission packets corresponding to the target data content presents that the total number of data transmission packets for transmission of the target data content. For example, if the data length of the target data content is 256 bytes, and the maximum transmission unit data is 100 bytes, then the total number of data transmission packets for example can be determined as 3 in order to meet the maximum transmission unit data of the target device.

The data transmission information corresponding to each data transmission packet presents the detailed transmission information in each data transmission packet. Specifically, the data transmission information corresponding to each data transmission packet comprises a data transmission packet code corresponding to the data transmission packet and the fragment data of the target data content corresponding to the data transmission packet.

The data transmission packet code corresponding to the data transmission packet presents the serial number of each data transmission packet, it is used to the distinguish the sequence or order of multiple data transmission packets. For example, if the data transmission packets are 3 packets, they can have data transmission packet code 00, 01, 02, respectively. The one or more embodiments of the disclosure are not limited to this.

The fragment data of the target data content corresponding to the data transmission packet presents the detailed fragment data of the target data content that transmitted by the data transmission packet. For example, if the data length of the target data content is 256 bytes, and the maximum transmission unit data is 100 bytes, and the total number of data transmission packets for example can be determined as 3. Then the fragment data of the target data content corresponding to the first data transmission packet can be the first 90 bytes in the target data content, the fragment data of the target data content corresponding to the second data transmission packet can be another 90 bytes which follows the first 90 bytes in the target data content, and the fragment data of the target data content corresponding to the third data transmission packet can be the last 76 bytes in the target data content.

Then in step S1043, a plurality of data transmission packets corresponding to the target data content based on the command identification verification information is generated according to a preset transmission format, the total number of data transmission packets and the data transmission information corresponding to each data transmission packet.

The preset transmission format presents the preset data packet format or data frame format, which, for example, defines the data size (bytes) of different types of data in the data transmission packet and the sequence of the different types of data. One or more embodiments of the present disclosure is not limited by the specific setting mode of the preset transmission format.

Specifically, the above process can be achieved, for each data transmission packet, by generating the transmission header part via the command identification code; generating the transmission payload load part via the total number of data transmission packets and the data transmission information of the data transmission packets; and splicing the transmission header part and the transmission payload part to obtain the data transmission packet.

Based on the above, by generating command identification verification information, determining a total number of data transmission packets corresponding to the target data content and data transmission information corresponding to each data transmission packet based on the data length of the target data content and the maximum transmission unit data, and generating, according to a preset transmission format, a plurality of data transmission packets corresponding to the target data content based on the command identification verification information, the total number of data transmission packets and the data transmission information corresponding to each data transmission packet, the communication method of the application can attain the plurality of data transmission packets corresponding to the target data content by a simple and convenient way, which is convenient to realize reliable data transmission with high real-time performance.

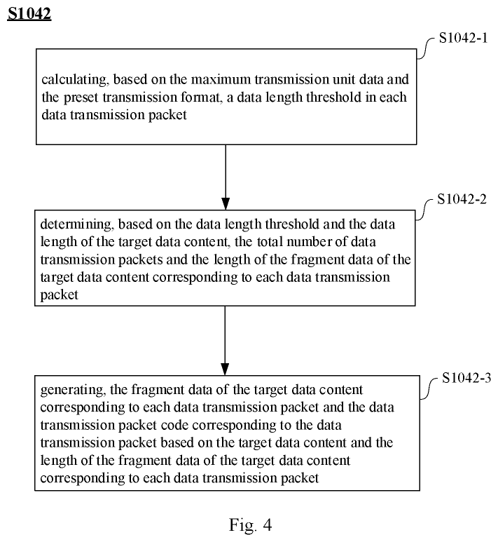

In one or more embodiments, wherein the process S1042 of determining, based on the data length of the target data content and the maximum transmission unit data, a total number of data transmission packets corresponding to the target data content and data transmission information corresponding to each data transmission packet can be described in more detail. FIG. 4 illustrates a schematic diagram of process S1042 according to one or more embodiments of the present disclosure.

Referring to FIG. 4, the above process S1042 comprises: firstly, in step S1042-1, a data length threshold in each data transmission packet is calculated based on the maximum transmission unit data and the preset transmission format. Specifically, the data length threshold in each data transmission packet presents the maximum data length of the fragment data of the target data content in each data transmission packet, i.e., the maximum amount of the fragment data of the target data content can be transmitted by the data transmission packet.

The above process can be described in more detail. Specifically, an example of the preset transmission format can be provided in the following table 1.

TABLE 1
an example of preset transmission format

| Section | Data Type | Size | |
|---|---|---|---|
| Header | Command identification code | 1 | byte |
| | Transmission payload length data | 1 | byte |
| Payload | Total number of data transmission packets | 1 | byte |
| | Data transmission packet code | 1 | byte |
| | Verification code | 2 | bytes |
| | Fragment data of the target data content | N | bytes |

Wherein for example, if the maximum transmission unit data are 100 bytes, and the preset transmission format is shown as table 1, then taking into account that the preset transmission format has arranged 6 bytes for other information (such as command identification code, total number of data transmission packets and so on), the data length threshold in each data transmission packet are 94 bytes, i.e., the maximum transmission unit minus the bytes for other types of data in the format.

Then, in step S1042-2, the total number of data transmission packets and the length of the fragment data of the target data content corresponding to each data transmission packet is determined based on the data length threshold and the data length of the target data content.

For example, if the data length of the target data content are 256 bytes, and the data length threshold in each data transmission packet are 94 bytes as described above, then the total number of data transmission packets can be calculated by the data length of the target data content and data length threshold in each data transmission packet, for example the total number of data transmission packets can be 3. And for example, the length of the fragment data of the target data content corresponding to three data transmission packets (first data transmission packet, second data transmission packet, third data transmission packet) can be described as 94, 94, 68, respectively. In addition, according to actual needs, the length of the fragment data of the target data content corresponding to three data transmission packets (first data transmission packet, second data transmission packet, third data transmission packet) can also be 68, 94, 94, or 94, 68, 94, or other bytes.

Then, in step S1042-3, the fragment data of the target data content corresponding to each data transmission packet and the data transmission packet code corresponding to the data transmission packet is generated based on the target data content and the length of the fragment data of the target data content corresponding to each data transmission packet.

Wherein the data transmission packet code corresponding to each data transmission packet is associated with the order of fragment data of the target data content in each data transmission packet in the target data content. For example, based on the above example, if the length of the fragment data of the target data content corresponding to three data transmission packets (first data transmission packet, second data transmission packet, third data transmission packet) are 94, 94, 68, respectively. Then the fragment data of the target data content corresponding to first data transmission packet can be the first 94 bytes in the target data content, and the data transmission packet code corresponding to the first data transmission packet can be “00” for example, which presents that the fragment data of the target data content corresponding to first data transmission packet is the data with the first order in the data content.

The fragment data of the target data content corresponding to second data transmission packet can be the next 94 bytes follows the first 94 bytes in the target data content, and the data transmission packet code corresponding to the first data transmission packet can be “01” for example, which presents that the fragment data of the target data content corresponding to second data transmission packet is the data with the second order (which comes after the fragment data of the target data content corresponding to first data transmission packet) in the data content.

The fragment data of the target data content corresponding to third data transmission packet can be the last 68 bytes in the target data content, and the data transmission packet code corresponding to the first data transmission packet can be “02” for example, which presents that the fragment data of the target data content corresponding to third data transmission packet is the data with the last order (which comes after the fragment data of the target data content corresponding to first data transmission packet and the second data transmission packet) in the data content.

Based on the above, by calculating a data length threshold in each data transmission packet based on the maximum transmission unit data and the preset transmission format, determining the total number of data transmission packets and the length of the fragment data of the target data content corresponding to each data transmission packet; and generating, the fragment data of the target data content corresponding to each data transmission packet and the data transmission packet code corresponding to the data transmission packet, the core information for the data transmission packets corresponding to the target data content can be determined in a simple and convenient way.

In one or more embodiments, wherein the command identification verification information further comprises a verification code corresponding to the target data content. The verification code presents a code used for verifying that the data of the multiple of data transmission packets comes from the same target data content. For example, the verification code can be generated for each target data content, then when the multiple of data transmission packets corresponding to the target data content are generated, the verification code can be carried by each of the data transmission packets, and the length of the verification code can be 2 bytes for example (as shown in table 1).

Based on the above, by arranging the command identification verification information further comprises a verification code corresponding to the target data content, the target device can use the verification code to verify that the fragment data of the target data content corresponding to each data transmission packet are derived from the same target data content. This can inhibit the target device from receiving error data due to interference or error in data transmission, or wrongly splicing fragment data of the data transmission packets that do not belong to the same target data content.

In one or more embodiments, wherein the content of the preset transmission format can be described in more detail. Specifically, as shown in Table 1, the preset transmission format may comprise a transmission header part and a transmission payload part.

Wherein the transmission header part presents the initial part of the preset transmission format, i.e., the data transmission packets. It may include the command identification code. The transmission payload part presents the core part of the preset transmission format, i.e., the data transmission packets. It may include the verification code, the total number of data transmission packets and the data transmission information of the data transmission packets. One or more embodiments of the present disclosure are not limited by the specific length allocation of the transmission header part and the transmission payload part.

Wherein the process S1043 of generating, according to a preset transmission format, a plurality of data transmission packets corresponding to the target data content based on the command identification verification information, the total number of data transmission packets and the data transmission information corresponding to each data transmission packet comprises: for each data transmission packet, firstly, the transmission payload part is generated via the verification code, the total number of data transmission packets and the data transmission information of the data transmission packets. Specifically, as shown in Table 1, the transmission payload part can be formed by splicing the total number of data transmission packets (1 byte), the data transmission packet code (1 byte), the verification code (2 bytes) and the fragment data of the target data content for the data transmission packet (for example N bytes) in sequence.

Then, the transmission header part is generated via the command identification code. Wherein the command identification code for example can be 1 byte, for example it can be “C1” in form of hexadecimal code. For example, the above steps may be performed simultaneously or sequentially, and one or more embodiments of the present disclosure are not limited thereto.

Then, the data transmission packet is obtained by splicing the transmission header part and the transmission payload part. Based on the above, by forming the preset transmission format with a transmission header part and a transmission payload part, generating the transmission header part via the command identification code; generating the transmission payload via the verification code, the total number of data transmission packets and the data transmission information of the data transmission packets; and splicing the transmission header part and the transmission payload part to obtain the data transmission packet, the data transmission packet can be formed in a simple and convenient way.

In one or more embodiments, wherein the transmission header part further comprises transmission payload length data. Wherein the transmission payload length data presents the amount of data the transmission payload part has, i.e., the length of the transmission payload part.

Wherein the process of generating the transmission header part via the command identification code for each data transmission packet comprises: firstly, for each data transmission packet, the data length (i.e., the data amount) of the transmission payload part of the data transmission packet is determined and taken as the transmission payload length data. Then, the command identification code is spliced with the transmission payload length data to obtain a transmission header part. In one or more embodiments, wherein data in the data transmission packet is expressed in hexadecimal code.

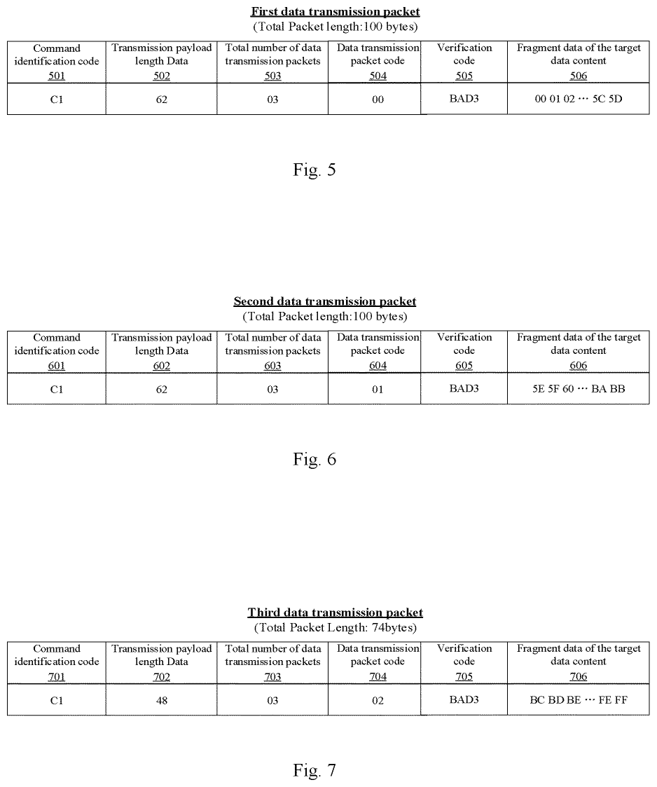

Based on the above, by arranging the data transmission packet is expressed in hexadecimal code, it is better to represent different types of data in the data transmission packet. For example, FIG. 5 illustrates a schematic diagram of a first data transmission packet according to one or more embodiments of the present disclosure. FIG. 6 illustrates a schematic diagram of a second data transmission packet according to one or more embodiments of the present disclosure. FIG. 7 illustrates a schematic diagram of a third data transmission packet according to one or more embodiments of the present disclosure. Wherein the data in the data transmission packet is expressed in hexadecimal code.

As shown in FIGS. 5 to 7, the communication method can be described in more detail. Specifically, if the data length of the target data content is 256 bytes, and a maximum transmission unit data of the target device is 100 bytes, and the preset transmission format is as shown in Table 1, then based on the above description, the data length threshold in each data transmission packet can be calculated as 94 bytes.

Then the command identification code 501, 601, 701 corresponding to the target data content can be set as hexadecimal code “C1” (1 byte), and the verification code 505, 605, 705 corresponding to the target data content can be set as hexadecimal code “BAD3” (2 bytes). Wherein based on the above description, the total number of data transmission packets 503, 603, 703 can be calculated as “03”, i.e., 3, and the length of the fragment data of the target data content corresponding to three data transmission packets (first data transmission packet, second data transmission packet, third data transmission packet) are 94, 94, 68, respectively.

Then based on the preset transmission format as shown in Table 1, the transmission payload length data 502 can be calculated as 98 bytes (presented as hexadecimal code “62”). Thus, the schematic diagram of a first data transmission packet is as shown in FIG. 5.

Wherein the total packet length of the first data transmission packet is 100 bytes, and as shown in FIG. 5, the transmission payload length data 502 is 98 (which is shown as hexadecimal code “62”), the fragment data of the target data content 506 corresponding to first data transmission packet can be the first 94 bytes in the target data content (which is shown as hexadecimal code from “00” to “5D”), and the data transmission packet code 504 corresponding to the first data transmission packet can be “00” for example.

The schematic diagram of a second data transmission packet is as shown in FIG. 6. Wherein the total packet length of the second data transmission packet is 100 bytes, the transmission payload length data 602 is 98 (which is shown as hexadecimal code “62”), the fragment data of the target data content 606 corresponding to second data transmission packet can be the next 94 bytes follows the first 94 bytes in the target data content (which is shown as hexadecimal code from “5E” to “BB”), and the data transmission packet code 604 corresponding to the second data transmission packet can be “01” for example.

The schematic diagram of a third data transmission packet is as shown in FIG. 7. Wherein the total packet length of the third data transmission packet is 74 bytes, the transmission payload length data 702 is 72 (which is shown as hexadecimal code “48”), the fragment data of the target data content 706 corresponding to third data transmission packet can be the last 68 bytes in the target data content (which is shown as hexadecimal code from “BC” to “FF”), and the data transmission packet code 704 corresponding to the third data transmission packet can be “02” for example.

In one or more embodiments, wherein the process S106 of receiving a plurality of data transmission packets corresponding to the target data content and determining the target data content based on the plurality of data transmission packets can be described in detailed: firstly, a plurality of data transmission packets corresponding to the target data content are determined based on the command identification code.

Specifically, based on the preset regulations, after reviewing the relative plurality of data transmission packets, based on the command identification code of the data transmission packets, the target device can determine that the plurality of data transmission packets with the command identification code are the data transmission packets corresponding to the target data content.

Then, according to the preset transmission format, the total number of the data transmission packets and data transmission information corresponding to each data transmission packet are determined based on the plurality of data transmission packets.

For example, if the preset transmission format as shown in Table 1, then for each data transmission packets, the target device can firstly read the transmission header part and pick the command identification code, and the transmission payload length data of the data transmission packet. Then based on the transmission payload length data and the preset transmission format, the target device can obtain the total number of data transmission packets, the data transmission packet code of the data transmission packets and fragment data of the target data content of the data transmission packets, i.e., the data transmission information corresponding to each data transmission packet. In addition, the target device can also obtain the verification code.

Then, fragment data of the target data content in a plurality of data transmission packets corresponding to the target data content is spliced based on data transmission information corresponding to each data transmission packet to obtain the target data content.

Specifically, the data transmission packet code of the data transmission packets and fragment data of the target data content of the data transmission packets, i.e., the data transmission information corresponding to each data transmission packet, the target device can determine the order of the fragment data of the target data content of each data transmission packet based on the data transmission packet code, and splice the fragment data of the target data content of each data transmission packet based on the order.

Based on the above, by the above arrangement, the target device of the disclosure can determine the target data content based on the plurality of data transmission packets in simple ways, so that the target data content split into and sent by multiple data transmission packets at the transmitting device can be well identified and combined at the target device, and finally the complete target data content is presented to the target device. A good and reliable transmission of the target command can be realized regardless of the MTU value of the target device, and data with larger size can be transmitted successfully.

In one or more embodiments, wherein splicing fragment data of the target data content in a plurality of data transmission packets corresponding to the target data content based on data transmission information corresponding to each data transmission packet to obtain the target data content can be described in detailed. Wherein the process can be described in detail: firstly, data transmission packet code of each data transmission packet is determined, for example, based on the preset transmission format and the data transmission packet. Then, according to the data transmission packet code of each data transmission packet, the fragment data of the target data content in each data transmission packet is spliced to obtain the target data content.

Based on the above, by the above arrangement, the target device can splice fragment data of the target data content in a plurality of data transmission packets corresponding to the target data content based on data transmission information corresponding to each data transmission packet to obtain the target data content in a simply and convenient way. In one or more embodiments, the data transmission packet further comprises a verification code as described above.

And the splicing, according to the data transmission packet code of each data transmission packet, the fragment data of the target data content in each data transmission packet to obtain the target data content can be described in detailed: firstly, the verification code in each data transmission packet is acquired.

For example, based on the preset transmission format, the target device can attain the verification code in each data transmission packet. Then, the target device can be configured to: only under the condition that the verification codes from each data transmission packet are the same, the step of splicing, according to the data transmission packet code of each data transmission packet, the fragment data of the target data content in each data transmission packet is executed.

Specifically, by the arrangement of only under the condition that the verification codes from each data transmission packet are the same, the step of splicing, according to the data transmission packet code of each data transmission packet, the fragment data of the target data content in each data transmission packet is executed, the source of the fragment data can be verified first (that is, the fragment data of different data transmission packets from the same target data content) and then the splicing process can be performed, thereby inhibiting the fragment data from different target content data from being wrongly spliced and improving the reliability of the communication process and the accuracy of data transmission. In one or more embodiments, wherein the target device is a Bluetooth speaker or a Bluetooth headset. Thus, by the settings in this application, the transmission of target data content (control commands or data content) to Bluetooth audio equipment can be well realized.

According to another aspect of the application, a communication system 200 based on Bluetooth low energy protocol is provided in the disclosure. As shown in FIG. 2, the communication system 200 based on Bluetooth low energy protocol comprises a transmitting device; and a target device, which communicates with the transmitting device based on Bluetooth low energy protocol. The communication system based on the Bluetooth low energy protocol is configured to execute the communication method for the communication system based on the Bluetooth low energy protocol as described above and can realize the functions as mentioned above.

Program portions of the technology may be considered to be “product” or “article” that exists in the form of executable codes and/or related data, which are embodied or implemented by a computer-readable medium. A tangible, permanent storage medium may include an internal memory, or a storage used by computers, processors, or similar devices or associated modules. For example, various semiconductor memories, tape drivers, disk drivers, or any similar devices capable of providing storage functionality for software.

All software or parts of it may sometimes communicate over a network, such as the internet or other communication networks. Such communication can load software from one computer device or processor to another. For example, loading from one server or host computer to a hardware environment of one computer environment, or other computer environment implementing the system, or a system having a similar function associated with providing information needed for the communication method. Therefore, another medium capable of transmitting software elements can also be used as a physical connection between local devices, such as light waves, electric waves, electromagnetic waves, etc., to be propagated through cables, optical cables, or air. Physical medium used for carrying the waves such as cables, wireless connections, or fiber optic cables can also be considered as medium for carrying the software. In usage herein, unless a tangible “storage” medium is defined, other terms referring to a computer or machine “readable medium” mean a medium that participates in execution of any instruction by the processor.

While various embodiments of the disclosure have been described, it will be apparent to those of ordinary skill in the art that many more embodiments and implementations are possible that are within the scope of the disclosure. Accordingly, the disclosure is not to be restricted except in light of the attached claims and their equivalents.

Unless otherwise expressly indicated herein, all numerical values indicating mechanical/thermal properties, compositional percentages, dimensions and/or tolerances, or other characteristics are to be understood as modified by the word “about” or “approximately” in describing the scope of the present disclosure. This modification is desired for various reasons including industrial practice, material, manufacturing, and assembly tolerances, and testing capability.

As used herein, the phrase at least one of A, B, and C should be construed to mean a logical (A OR B OR C), using a non-exclusive logical OR, and should not be construed to mean “at least one of A, at least one of B, and at least one of C.”

In this application, the term “controller” and/or “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components (e.g., op amp circuit integrator as part of the heat flux data module) that provide the described functionality; or a combination of some or all of the above, such as in a system-on-chip.

The term memory is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general-purpose computer to execute one or more particular functions embodied in computer programs. The functional blocks, flowchart components, and other elements described above serve as software specifications, which can be translated into the computer programs by the routine work of a skilled technician or programmer.

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A communication method for a communication system based on a Bluetooth low energy protocol, the communication system comprising a transmitting device and a target device, and the communication method comprising:
the transmitting device is configured to:
acquire a target data content;
acquire a maximum transmission unit data of the target device;
compare a data length of the target data content with the maximum transmission unit data;
generate a plurality of data transmission packets corresponding to the target data content according to a preset rule when the data length of the target data content is greater than the maximum transmission unit data; and
send the plurality of data transmission packets to the target device based on the Bluetooth low energy protocol;
wherein the target device is configured to: receive the plurality of data transmission packets corresponding to the target data content, and determine the target data content based on the plurality of data transmission packets;
wherein the data length of each data transmission packet is less than or equal to the maximum transmission unit data of the target device.

2. The communication method according to claim 1, wherein the step of generating the plurality of data transmission packets corresponding to the target data content according to the preset rule when the data length of the target data content is greater than the maximum transmission unit data comprises:
generating command identification verification information corresponding to the target data content, wherein the command identification verification information comprises a command identification code;
determining, based on the data length of the target data content and the maximum transmission unit data, a total number of data transmission packets corresponding to the target data content and data transmission information corresponding to each data transmission packet, wherein the data transmission information corresponding to each data transmission packet comprises a data transmission packet code corresponding to the data transmission packet and fragment data of the target data content corresponding to the data transmission packet; and
generating, according to a preset transmission format, a plurality of data transmission packets corresponding to the target data content based on the command identification verification information, the total number of data transmission packets and the data transmission information corresponding to each data transmission packet.

3. The communication method according to claim 2, wherein the step of determining, based on the data length of the target data content and the maximum transmission unit data, the total number of data transmission packets corresponding to the target data content and data transmission information corresponding to each data transmission packet comprises:
calculating, based on the maximum transmission unit data and the preset transmission format, a data length threshold in each data transmission packet;
determining, based on the data length threshold and the data length of the target data content, the total number of data transmission packets and the length of the fragment data of the target data content corresponding to each data transmission packet; and
generating, the fragment data of the target data content corresponding to each data transmission packet and the data transmission packet code corresponding to the data transmission packet based on the target data content and the length of the fragment data of the target data content corresponding to each data transmission packet;
wherein the data transmission packet code corresponding to each data transmission packet is associated with an order of fragment data of the target data content in each data transmission packet in the target data content.

4. The communication method according to claim 2, wherein the command identification verification information further comprises a verification code corresponding to the target data content.

5. The communication method according to claim 4, wherein a preset transmission format comprises a transmission header part and a transmission payload part;
and the step of generating, according to the preset transmission format, the plurality of data transmission packets corresponding to the target data content based on the command identification verification information, the total number of data transmission packets and the data transmission information corresponding to each data transmission packet comprises:
for each data transmission packet:
generating the transmission payload part via the verification code, the total number of data transmission packets and the data transmission information of the data transmission packets;
generating the transmission header part via the command identification code; and
splicing the transmission header part and the transmission payload part to obtain the data transmission packet.

6. The communication method according to claim 5, wherein the transmission header part further comprises transmission payload length data;
and the step of generating the transmission header part via the command identification code for each data transmission packet comprises:
for each data transmission packet:
determining the data length of the transmission payload part of the data transmission packet and taking it as the transmission payload length data; and
splicing the command identification code with the transmission payload length data to obtain the transmission header part.

7. The communication method according to claim 1, wherein data in the data transmission packet is expressed in hexadecimal code.

8. The communication method according to claim 2, wherein the step of receiving the plurality of data transmission packets corresponding to the target data content, and determining the target data content based on the plurality of data transmission packets comprises:
determining the plurality of data transmission packets corresponding to the target data content based on the command identification code;
determining, according to the preset transmission format, the total number of the data transmission packets and the data transmission information corresponding to each data transmission packet based on the plurality of data transmission packets; and
splicing fragment data of the target data content in the plurality of data transmission packets corresponding to the target data content based on data transmission information corresponding to each data transmission packet to obtain the target data content.

9. The communication method according to claim 8, wherein the step of splicing fragment data of the target data content in the plurality of data transmission packets corresponding to the target data content based on data transmission information corresponding to each data transmission packet to obtain the target data content comprises:
determining data transmission packet codes of each data transmission packet; and
splicing, according to the data transmission packet code of each data transmission packet, the fragment data of the target data content in each data transmission packet to obtain the target data content.

10. The communication method according to claim 9, wherein the data transmission packet further comprises a verification code, and splicing, according to the data transmission packet code of each data transmission packet, the fragment data of the target data content in each data transmission packet to obtain the target data content comprises:
acquiring the verification code in each data transmission packet; and
only under a condition that the verification codes from each data transmission packet are the same, the step of splicing, according to the data transmission packet code of each data transmission packet, the fragment data of the target data content in each data transmission packet is executed.

11. The communication method according to claim 1, wherein the target device is a Bluetooth speaker or a Bluetooth headset.

12. A communication system based on Bluetooth low energy protocol, comprising:
a transmitting device; and
a target device, which communicates with the transmitting device based on the Bluetooth low energy protocol;
wherein the communication system based on the Bluetooth low energy protocol is configured to execute the communication method for the communication system based on the Bluetooth low energy protocol as claimed in claim 1.
